(19) United States
(12) Patent Application Publication
(10) Pub. No.: US 2007/0278773 A1
(43) Pub. Date: Dec. 6, 2007

(54) Airbag Living Hinge Assembly

(75) Inventors: Glenn A. Cowelchuck, Chesterfield Township, MI (US); Todd L. DePue, Brighton, MI (US); Robert J. Adams, Ypsilanti, MI (US); Michael W. Cass, Lenox, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 11/422,080

(22) Filed: Jun. 4, 2006

(51) Int. Cl. B60R 21/205; B60R 21/217

(52) U.S. Cl. 280/732; 280/728.2; 280/728.3

(57) ABSTRACT

An airbag assembly is provided including an instrument panel substrate with an outer display surface and a panel opening formed therein. A door panel is positioned over the panel opening. A chute element is positioned behind and mounted to the instrument panel substrate. It includes an upper chute mating surface mounted to the instrument panel substrate, a chute chamber orientated coincident with the panel opening, and a plurality of chute sidewalls. A living hinge assembly includes a hinge sidewall portion slidably engaged to one of the chute sidewalls, a hinge door portion attached to the hinge sidewall portion by a living hinge portion allowing them to relatively rotate. The hinge door portion is mounted to the door panel. An airbag module is mounted to the chute element and deploys upward through the chute chamber. The living hinge assembly slides upward during deployment to clear the outer display surface.

### TECHNICAL FIELD

The present invention relates generally to a seamless airbag assembly and more particularly to a simplified airbag assembly with improved appearance that utilizes living hinges.

### BACKGROUND OF THE INVENTION

Automotive designs are an amalgamation of a host of design considerations. Designs must be aesthetically pleasing, functionally reliable, and safe. With introduction of more and more technologies into the vehicle interior, space is also a driving issue. The increase in features and technologies often threatens to overwhelm the smooth and flowing design of the instrument panel. As such, considerable design care is taken to not let functionality overwhelm ergonomics and appearance.

One particular technological element that poses redesigning considerations is the introduction of airbag assemblies into the instrument panel. These airbag assemblies often leave a considerable visual impact on the instrument panel. Their size and often protruding nature from the surrounding Class-A surface is often unappealing. In addition, the difficulty of proper installation during manufacture and assembly pose considerable time and labor issues.

It would therefore be highly desirable to have an airbag assembly design that improved the outer appearance of the assembly after installation. It would further be highly desirable to have an airbag assembly design with improve manufacturing and assembly to promote simplicity in manufacture and installation.

### SUMMARY OF THE INVENTION

In accordance with the objects of the present invention an airbag assembly is provided including an instrument panel substrate with an outer display surface and a panel opening formed therein. A door panel is positioned over the panel opening. A chute element is positioned behind and mounted to the instrument panel substrate. It includes an upper chute mating surface mounted to the instrument panel substrate, a chute chamber orientated coincident with the panel opening, and a plurality of chute sidewalls. A living hinge assembly includes a hinge sidewall portion slidably engaged to one of the chute sidewalls, a hinge door portion attached to the hinge sidewall portion by a living hinge portion allowing them to relatively rotate. The hinge door portion is mounted to the door panel. An airbag module is mounted to the chute element and deploys upward through the chute chamber. The living hinge assembly slides upward during deployment to clear the outer display surface.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of an airbag assembly in accordance with the present invention.

FIG. 2 is a cross-sectional illustration of a portion the airbag assembly illustrated in FIG. 1.

FIG. 3 is a cross-sectional illustration of the airbag assembly illustrated in FIG. 1.

FIG. 4 is a detail cross-sectional illustration of an airbag assembly in accordance with the present invention.

### DESCRIPTION OF PREFERRED EMBODIMENTS

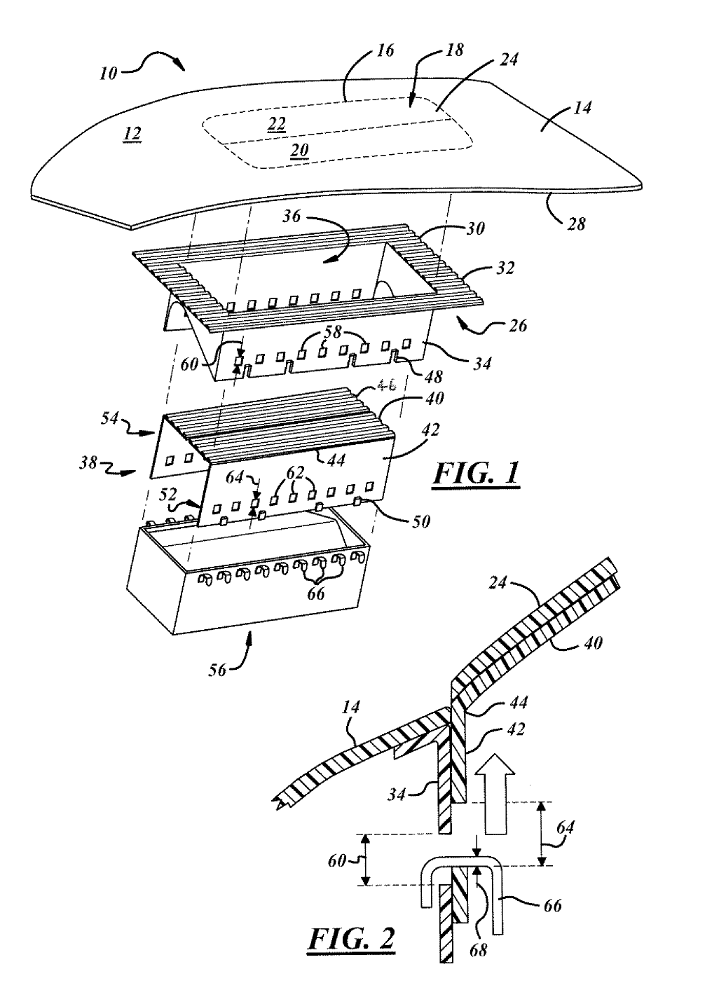

Referring now to FIG. 1, which is an exploded view illustration of an airbag assembly 10 in accordance with the present invention. The airbag assembly 10 in intended for installation into any of a wide variety of vehicles and as a portion of a wide variety of passenger safety systems. The airbag assembly 10 includes an instrument panel substrate 12. The precise shape and configuration of the instrument panel substrate 12 will be subject to the vehicle and system to which the present invention is applied. The instrument panel substrate 12 preferably includes an outer display surface 14 comprising a class-A surface exposed to customer viewing.

A panel opening 16 is formed within the instrument panel substrate 12. Although this may be accomplished through a variety of manufacturing techniques, one embodiment contemplates the use of laser scoring to remove a piece of the instrument panel substrate 12 in order to form the panel opening 16. The advantage of this method is that at least one door panel 18 can be formed by this laser scoring that will, in turn, be able to be utilized as a virtually seamless door panel 18 for the airbag assembly 10. In one embodiment, it is contemplated that the door panel 18 be comprised of a first door panel 20 and a second door panel 22. A secondary advantage of laser scoring the door panels 20,22 out of the instrument panel substrate 12 is that it provides a door outer surface 24 having singular appearance with the instrument panel 12 prior to airbag activation.

The present invention further includes the use of a chute element 26 mounted to the inner panel surface 28 of the instrument panel substrate 12. The chute element 26 includes an upper chute mating surface 30 formed to mate with the inner panel surface 28. In at least one embodiment, the upper chute mating surface 30 includes a chute corrugated surface 32. A plurality of chute sidewalls 34 extend downward from the upper chute mating surface 30 and are configured to form a chute chamber 36. The chute chamber 36 is preferably sized to extend slightly within the perimeter of the panel opening 16.

A living hinge assembly 38 is positioned within the chute chamber 36. The living hinge assembly 38 includes a hinge door portion 40 and a hinge sidewall portion 42 connected by way of a living hinge portion 44. The hinge door portion 40 is configured to mount to the door panel 18. In one embodiment, the hinge door portion 40 includes a hinge corrugated surface 46 which can be vibration welded to the door panel 18. The living hinge assembly 38 is mounted within the chute chamber 36 while retaining the ability to slide vertically within. It is further contemplated that the living hinge assembly 38 is actually comprised of a first living hinge assembly 52 and a second living hinge assembly 54.

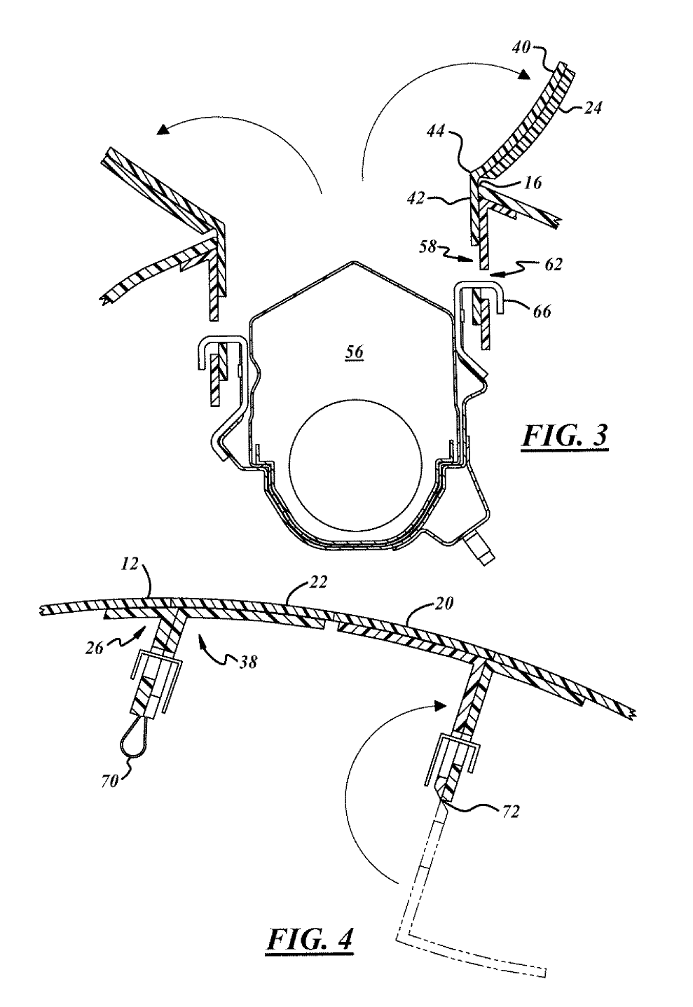

An airbag module 56 is mounted to the chute element 26 is orientated such that when deployed it will deploy upward through the chute chamber 36. Upon deployment, the living hinge assembly 38 will slide upward within the chute chamber 36 to allow the living hinge portion 44 to move outwards to clear the outer display surface 14 (see FIG. 2) prior to the door panels 20,22 swinging outward about the living hinge portion 44 (see FIG. 3). This allows the door panels 20,22 to remain flush with the outer display surface 14 prior to deployment. This provides for an improved surface appearance while retaining improved deployment performance.

Although the ability of the living hinge assembly 38 to slide clear of the outer display surface 14 may be accomplished in a variety of fashions, one embodiment contemplates a plurality of chute retention slots 58 formed in the chute sidewalls 34. Each of the chute retention slots 58 includes a chute slot depth 60, A plurality of hinge retention slots 62 are formed in the hinge sidewalls 42 and correspond to the chute retention slots 58. Each of the hinge retention slots 62 includes a hinge slot depth 64. A plurality of airbag retention hooks 66 are mounted to the airbag module 56 and are assembled to pass through the chute retention slots 58 and the hinge retention slots 62. This mounts the airbag module 56 to the chute element 26. Each of the airbag retention hooks 66 has a hook width 68. The hook width 68 is sufficiently less than the hinge slot depth 64 to precisely allow the amount of relative sliding of the living hinge assembly 38 such that the living hinge portion 44 clears the outer display surface 14 during airbag deployment.

Another novel feature of the present invention contemplates a further reduction is manufacturing and assembly simplicity. It is contemplated that the living hinge assembly 38 and the chute element 26 maybe molded as a single element to conserve manufacturing and assembly costs. In addition to manufacturing simplicity, this also insures proper orientation in combination with the vertical movement. Two contemplated configurations are shown in FIG. 4. It is contemplated that a loop hinge element 70 may be formed to connect the living hinge assembly 38 and the chute element 26 during molding. It is contemplated that the loop hinge 70 he configured to allow the required vertical sliding previously described. Alternatively, it is contemplated that the living hinge assembly 38 may be molded in connection to the chute element 26 by way of a break-away hinge 72. In this embodiment, as the living hinge assembly 38 is rotated up into the chute chamber 36 the break-away hinge 62 is fractured to allow vertical motion. Alternatively, the break-away hinge 62 may remain affixed but will fracture during airbag deployment.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An airbag assembly comprising:
an instrument panel substrate including an outer display surface;
a panel opening formed into said instrument panel substrate;
at least one door panel positioned over said panel opening, said at least one door panel includes a door outer surface;
a chute element positioned behind and mounted to said instrument panel substrate, said chute element comprising;
an upper chute mating surface mounted to said instrument panel substrate;
a chute chamber orientated coincident with said panel opening;
a plurality of chute sidewalls extending away from said upper chute mating surface; and
a plurality of chute retention slots formed in said plurality of chute sidewalls, each of said chute retention slots having a chute slot depth;
at least one living hinge assembly comprising:
a hinge sidewall portion;
a hinge door portion attached to said hinge sidewall portion by a living hinge portion, said hinge door portion mounted to said at least one door panel and rotatable relative to said hinge sidewall portion; and
a plurality of hinge retention slots configured to correspond with said plurality of chute retention slots, each of said hinge retention slots having a hinge slot depth;
an airbag module including a plurality of airbag retention hooks, said airbag module mounted to said chute element by way of said airbag retention hooks positioned within said plurality of chute retention slots and said plurality of hinge retention slots, said airbag module configured to deploy upward through said chute chamber and outward from said panel opening, said airbag retention hooks having a hook width smaller than said hinge slot depth and said chute slot depth such that said living hinge assembly slides upward within said chute chamber during deployment such that said living hinge portion moves outward from said outer display surface.

2. An airbag assembly as described in claim 1 wherein said at least one door panel comprises a portion of said instrument panel substrate laser scored away to form said panel opening.

3. An airbag assembly as described in claim 1, wherein said at least one living hinge assembly is molded as a single element with said chute element, said living hinge assembly configured to move vertically relative to said chute element.

4. An airbag assembly as described in claim 1, wherein said hinge door portion is vibration welded to said door panel.

5. An airbag assembly as described in claim 1, wherein said at least one door panel comprises a first door panel and a second door panel; and
said at least one living hinge assembly comprises a first living hinge assembly and a second living hinge assembly.

6. An airbag assembly as described in claim 1, wherein said base door outer surface is flush with said outer display surface prior to deployment of said airbag module.

7. An airbag assembly as described in claim 1, wherein said at least one living hinge assembly is molded as a single element with said chute element, said hinge sidewall portion connected to one of said chute sidewalls by way of a loop hinge, said loop hinge allowing vertical movement of said hinge sidewall portion relative to said chute sidewall.

8. An airbag assembly as described in claim 1, wherein said at least one living hinge assembly is molded as a single element with said chute element, said hinge sidewall portion connected to one of said chute sidewalls by way of a break-away hinge, said break-away hinge breakable to allow vertical movement of said hinge sidewall portion relative to said chute sidewall.

9. An airbag assembly comprising;
an instrument panel substrate including an outer display surface;
a panel opening formed into said instrument panel substrate;
at least one door panel positioned over said panel opening, said at least one door panel includes a door outer surface;
a chute element positioned behind and mounted to said instrument panel substrate, said chute element comprising:
an upper chute mating surface mounted to said instrument panel substrate;
a chute chamber orientated coincident with said panel opening;
a plurality of chute sidewalls extending away from said upper chute mating surface;
at least one living hinge assembly comprising:
a hinge sidewall portion slidably engaged to one of said plurality of chute sidewalls;
a hinge door portion attached to said hinge sidewall portion by a living hinge portion, said hinge door portion mounted to said at least one door panel and rotatable relative to said hinge sidewall portion;
an airbag module mounted to said chute element, said airbag module configured to deploy upward through said chute chamber and outward from said panel opening, said living hinge assembly sliding upward within said chute chamber during deployment such that said living hinge portion moves outward from said outer display surface.

10. An airbag assembly as described in claim 9, wherein said at least one door panel comprises a portion of said instrument panel substrate laser scored away to form said panel opening.

11. An airbag assembly as described in claim 9, wherein said at least one living hinge assembly is molded as a single element with said chute element, said living hinge assembly configured to move vertically relative to said chute element.

12. An airbag assembly as described in claim 9, wherein said hinge door portion is vibration welded to said door panel.

13. An airbag assembly as described in claim 9, wherein said base door outer surface is flush with said outer display surface prior to deployment of said airbag module.

14. An airbag assembly as described in claim 9, wherein said at least one living hinge assembly is molded as a single element with said chute element, said hinge sidewall portion connected to one of said chute sidewalls by way of a loop hinge, said loop hinge allowing vertical movement of said hinge sidewall portion relative to said chute sidewall.

15. An airbag assembly as described in claim 9, wherein said at least one living hinge assembly is molded as a single element with said chute element, said hinge sidewall portion connected to one of said chute sidewalls by way of a break-away hinge, said break-away hinge breakable to allow vertical movement of said hinge sidewall portion relative to said chute sidewall.

16. A method of assembling an airbag assembly comprising:
forming a panel opening into an instrument panel substrate having an outer display surface;
mounting a chute element behind said instrument panel substrate, said chute element comprising:
an upper chute mating surface mounted to said instrument panel substrate;
a chute chamber orientated coincident with said panel opening;
a plurality of chute sidewalls extending away from said upper chute mating surface;
slidably mounting a living hinge assembly within said chute chamber, said living hinge assembly comprising:
a hinge sidewall portion slidably engaged to one of said plurality of chute sidewalls;
a hinge door portion attached to said hinge sidewall portion by a living hinge portion, said hinge door portion mounted to a door panel and rotatable relative to said hinge sidewall portion;
mounting an airbag module to said chute element such that during deployment said living hinge assembly slides upward within said chute chamber such that said living hinge portion moves outward from said outer display surface.

17. A method as described in claim 16, further comprising:
laser scoring said instrument panel substrate to form said panel opening and said door panel.

18. A method as described in claim 16, further comprising:
vibration welding said door panel to said hinge door portion.

19. A method as described in claim 16, further comprising:
forming said at least one living hinge assembly and said chute element as a single element, said hinge sidewall portion connected to one of said chute sidewalls by way of a loop hinge, said loop hinge allowing vertical movement of said hinge sidewall portion relative to said chute sidewall.

20. A method as described in claim 16, further comprising:
forming said at least one living hinge assembly and said chute element as a single element, said hinge sidewall portion connected to one of said chute sidewalls by way of a break-away hinge, said break-away hinge breakable to allow vertical movement of said hinge sidewall portion relative to said chute sidewall.
